(19) United States
(12) Patent Application Publication
(10) Pub. No.: US 2004/0181469 A1
(43) Pub. Date: Sep. 16, 2004

(54) Accounting management method for grid computing system

(76) Inventor: Yuji Saeki, Ebina (JP)

Correspondence Address: ANTONELLI, TERRY, STOUT & KRAUS, LLP, 1300 NORTH SEVENTEENTH STREET, SUITE 1800, ARLINGTON, VA, 22209-9889, US

(21) Appl. No.: 10/756,249

(22) Filed: Jan. 14, 2004

(30) Foreign Application Priority Data
Mar. 10, 2003 (JP) 2003-063580

(51) Int. Cl. G06F 17/60

(52) U.S. Cl. 705/30

(57) ABSTRACT

An accounting management method in grid computing which ensures security and validity and reduces manager burdens is disclosed. An accounting certificate for a server in which a tariff for computing resources available on the server is stated and attached with the digital signature of a certificate authority (CA) of accounting is prepared. An accounting certificate for resources user (ACRU) in which a credit authorized for the user to be spent to utilize resources is stated and attached with the digital signature of the CA of accounting is prepared. When initiating a session in which the client submits a request for service processing to a server and obtains a response, the client sends the server the ACRU and a proxy including a credit amount allocated for service usage in the session as a part of the authorized credit and attached with the client's digital signature. The server authenticates the signatures on the ACRU and proxy in a concatenate way by using a public key of the CA of accounting and accepts the request for service processing. If the server calls on a subordinate server to execute a part of the processing, the server creates a second proxy including a credit amount allocated for sub-processing as a part of the credit stated in the foregoing proxy and passes the second proxy to the subordinate server.

### FIELD OF THE INVENTION

The present invention relates to an accounting management method in which a server system for processing a workflow consisting of applications which require authentication and accounting procedures in a grid computing environment performs accounting management, based on credit information obtained from a user in a proxy.

### BACKGROUND OF THE INVENTION

Research and development of grid computing technology in which geographically distributed computers are connected via the Internet and which enables the execution of a process by sharing the computer resources with each other are now being pursued actively.

In the grid computing environment, users need not know details on data, programs, computers, and storage to be used, such as their locations and specifications, and, among a collection of resources whose configurations according to process workflow and service level such as charges and response time are pooled, suitable resources are automatically selected to execute a process requested by a user, according to the operating status of the resources and the user's entitlement.

One technique characteristic of the grid computing is single sign-on. This single sign-on enables process execution once the user has entered his or her password even for the process that should be executed, using a plurality of resources respectively belonging to a plurality of organizations.

Aiming at development, improvement, and standardization of middleware that forms a foundation for realizing the grid computing, implementation of a Globus toolkit (http://www.gridforum.org/) is pursued under the consensus of a Global Grid Forum (http://www.gridforum.org/). The Globus toolkit as of now has the functions of remote job execution, providing information for servers participating in the grid computing, data copy management, and high-speed data transfer, and these functions are performed under a security mechanism based on public-key cryptography.

The security mechanism of the Globus toolkit is as follows. A server and a user participating in the grid computing have their certificates that are issued with the signature made by a certificate authority that both parities of the server and the user trust. When initiating a session, the user creates a pair of a public key and a private key for the session, creates a proxy including the public key and the user's signature thereon, and passes the proxy to the server to which the user submits a request for a service process. The server refers to this proxy and executes the service process by using the access right of the user.

If the service process calls on another server to execute a service process, the server creates a new pair of a public key and a private key, creates a proxy including its public key and its signature thereon made by using its private key for the proxy, and passes the proxy to another server to which the server submits the request for the service. Through a chain of certificate and proxy transfers from one server to another in this manner, the access right of the user can be delegated to the back-end server.

As regards accounting, based on a “grid-mapfile” text file in which a mapping between organization name/user name which is used to identify the user in the grid computing and user ID on a local machine basis is described, charges per user ID calculated by a tariff (accounting policy) for a local machine are charged to the organization/user having the user ID.

[Non-Patent Document 1]

Rajkumar Buyya, David Abramson, Jonathan Giddy, and Heinz Stockinger, “Economic models for resource management and scheduling in Grid computing” pp. 1508-1512, “PDF,” Jan. 6, 2002, retrieved for reference on Feb. 10, 2003, through the Internet at

<URL:http://www.buyya.com/papers/emodelsgrid.pdf>

However, there are problems associated with the accounting management using the above-mentioned grid-mapfile. Great burdens are imposed on accounting managers in the situation where a variety of access requests are submitted throughout all over the world. Additional measures for preventing tampering with accounting information are required.

In order to increase services available in the grid computing environment, accounting arrangements for charged services are necessary. For the accounting, protection against tampering with information about accounting exchanged on a network must be taken and, moreover, a mechanism for ensuring the validity of the accounting information must be provided so that a workflow that a user wants to have executed can be served by an optimum system not affected by geographical and organizational restrictions. In other words, as the user need not know which server completes the request to execute a process from the user, it is essential to build an infrastructure for accounting on which all server systems that the user is entitled to use can recognize each other. Without such an infrastructure, cross-border linkage for services across the organizations cannot be realized.

It is assumed that users may belong to virtual organizations independent of real organizations and make a problem solution, taking advantage of shared resources. Configurations of such virtual organizations change constantly and forming a virtual organization, its dormancy and dissolution, and changing its members including members who belong to more than one organization occur more frequently than in real organizations. In these fluid circumstances, accurate accounting appropriate for use purposes must be performed.

In view of convenience, all necessary setting should be completed when the user initiates a session as is the case for single sign-on user authentication. It is not desirable that, each time a workflow (a set of processes) that the user wants to have executed comes upon a charged service, accounting information for the service must be exchanged between the service requester client or service execution server and a server that is responsible for centralized management of users or accounting information.

From the perspective of a server manager, as access can occur not subjected to geographical and organizational restrictions, the number of users that the manager must manage multiplies, organizational affiliation of users frequently changes because of fluid configurations of virtual organizations, and the burdens of the manager involved in accounting management significantly multiply.

### SUMMARY OF THE INVENTION

In view of the-above-described problems of prior art, it is therefore an object of the present invention to provide an accounting management method that is advantageous in security, validity, and convenience and by which the manager burdens are reduced.

In an accounting management method for use in grid computing in accordance with the present invention, for servers, each having shared computing resources, an accounting certificate for a server in which a tariff for computing resources available on the server is stated and attached with the digital signature of a certificate authority of accounting thereon is prepared. For clients, an accounting certificate for resources user in which a credit that the user is allowed to spend to utilize resources is stated and attached with the digital signature of the certificate authority of accounting thereon is prepared. When initiating a session in which the client submits a request for service processing to a server and obtains a response, the client sends the server the above accounting certificate for resources user and a proxy including a statement of a credit allocated for service usage in the session as a part of the authorized credit and the client's public key and attached with the client's digital signature thereon. The server authenticates the signature on the received accounting certificate for resources user by using a public key of the certificate authority of accounting, authenticates the signature on the proxy by using the client's public key stated in the above certificate, and accepts the request for service processing. If the server calls on a subordinate server to execute a part of the processing in a concatenate way, the method is further characterized by including an additional step in which the server creates a second proxy including a statement of a credit allocated for sub-processing as a part of the credit stated in the foregoing proxy and passes the second proxy to the subordinate server to which a request for processing is submitted.

According to the present invention, accounting information is managed in conjunction with a single sign-on authentication protocol for remote access to computing resources in grid computing. Because such management is based on certificates attached with the signature of the certificate authority of accounting that both the client and the server trust, a risk of tampering with accounting information is as small as a risk of unauthorized access to computing resources and the single sign-on convenience feature can be sustained. The certificate authority of accounting is able to perform management by balancing out accounts per virtual organization as a settlement agency and, consequently, accounting management tasks for virtual organizations can be reduced.

Because the same mechanism is used to authenticate user identity and accounting, if the certificate authority of accounting operates in conjunction with a certificate authority for identity authentication, credit information created at the start of a session can be valid for all servers for which user authorization is granted. Even if configuration change is made to virtual organizations, altered identity attributes are updated on the certificate authority and, therefore, accurate accounting can be performed.

Tempering with credit information can be prevented, because the credit information for utilizing charged services is stated in certificates protected by public-key cryptography and signed by a chain of entities with the certificate authority of accounting, a third-party entity that both the user and the server trust, being on the top level.

### BRIEF DESCRIPTION OF THE DRAWINGS

FIG. 1 is a system schematic diagram for illustrating a preferred embodiment of the present invention, which depicts a chain of certificate and proxy transfers for single sign-on authentication for authorization;

FIG. 2 is a diagram for illustrating single sign-on authentication for accounting and for explaining the steps of issuing or updating an accounting certificate for user and an accounting certificate for server;

FIG. 3 illustrates an example of a service tariff which is included in an accounting certificate for server;

FIG. 4 is a diagram for explaining a client system operation step to initiate a session;

FIG. 5 illustrates an example of an input screen which the client system presents when the user wants to initiate a session;

FIG. 6 is a diagram for explaining a step of obtaining accounting information on a server at the start of a session;

FIG. 7 is a diagram for explaining a step for user right delegation from one server to another server;

FIG. 8 is a diagram for explaining a step of credit allocation for user right delegation from one server to another server;

FIG. 9 is a diagram for explaining a step of obtaining accounting information without user right delegation from one server to another server;

FIG. 10 is a diagram for explaining a step of creating bills for service usage on the server upon the termination of a workflow;

FIG. 11 is a diagram for explaining a step of receiving and storing bills for service usage on the client system upon the termination of a workflow;

FIG. 12 is a diagram for explaining a step of summing up accounts on a per-organization basis, which is periodically performed concurrently with a certificate update request; and

FIG. 13 is a diagram for explaining summation servers, each being set up per organization.

### DETAILED DESCRIPTION OF THE PREFERRED EMBODIMENTS

A preferred embodiment of the present invention will be described hereinafter, based on the accompanying drawings.

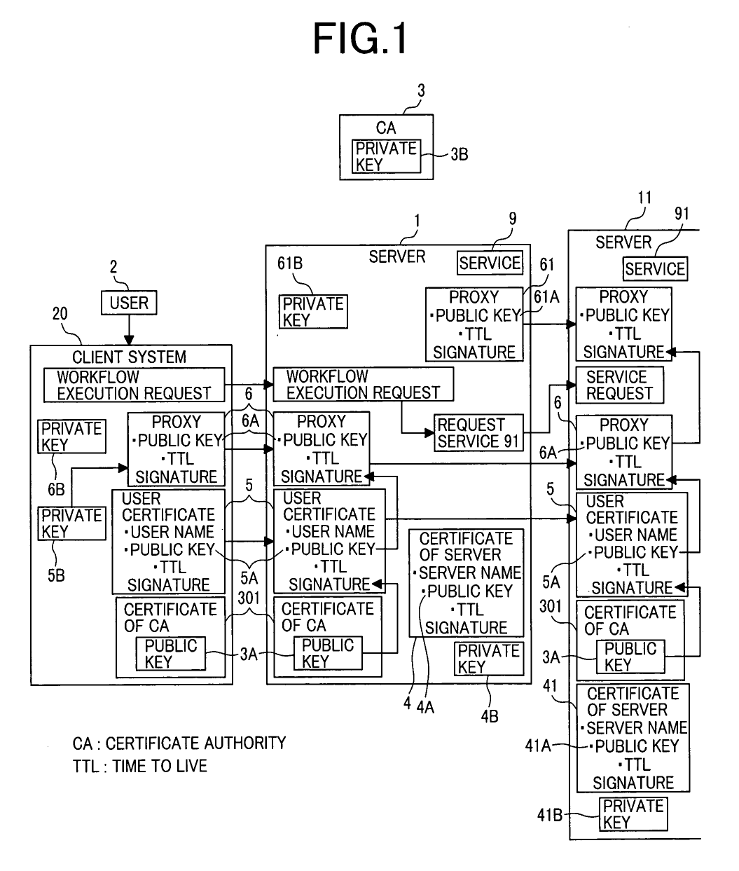

FIG. 1 is a diagram showing an overall accounting management procedure. Delegation of the user's right is carried out by passing a user certificate 5 and a proxy 6 shown in FIG. 1 to a server and from the server to another server and accounting management is performed by exchanging accounting information in conjunction with or in parallel with a mechanism enabling single sign-on.

First, a certificate authority of accounting (second certificate authority) 300 is set up, based on public-key cryptography and in conjunction with a certificate authority (first certificate authority) 3 which makes its signature on certificates 4 and 5 that are used to authenticate a server 1 and a user 2. The certificate authorities may be certificate authority servers.

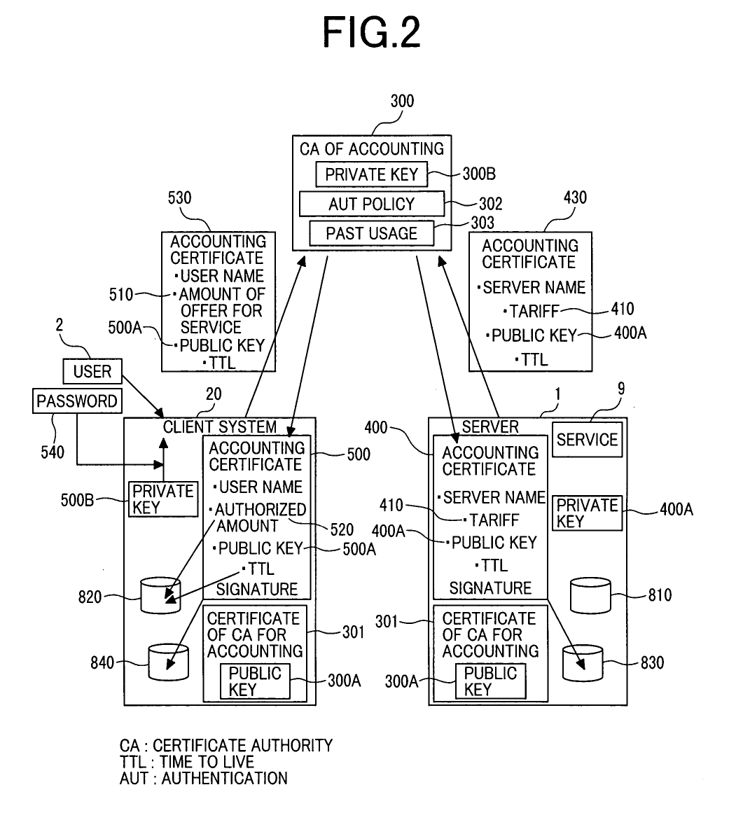

All servers represented by the server 1 and all users represented by the user 2 participating in the grid computing periodically submit a request to issue or update certificates 4 and 5 that are effective for each server or user identification for a certain period to the certificate authority 3. In synchronization with this request for a certificate, the user 2 submits a request to issue or update a certificate (accounting certificate for user) 500 that proves the user's ability to pay for a certain period to the certificate authority of accounting 300 which is shown in FIG. 2.

In an authentication procedure in FIG. 1, the servers 1, 11 and the user 2 participating in the grid computing respectively obtain the certificates 4, 41, and 5 signed and issued by the certificate authority 3 that these entities trust. When initiating a session, the user 2 creates a pair of a public key 6A and a private key 6B for the session, creates a proxy 6 including a time to live and its public key 6A with the signature of the user 2, and passes the proxy 6 to the server 1 to which a request to execute a service process 9 is submitted. The server 1 refers to the proxy and executes the service process 9 by using the access right of the user 2.

If the service process 9 calls on another server (a subordinate server) 11 to execute a service process 91, the server 1 creates a new pair of public key 61A and a private key 61B, creates a proxy 61 including its pubic key 61A and the server's signature made thereon by using its private key 61B for the proxy 6, and passes the proxy to the server 11. Through a chain of certificate and proxy transfers from one server to another in this manner, the access right of the user 2 can be delegated to the back-end server.

FIG. 2 is a diagram showing an overall accounting management procedure. A client system 20 used by the user 2 has a certificate 301 of the certificate authority for accounting including the public key 300A of the certificate authority of accounting 300. The client system 20 sends the certificate authority of accounting 300 a request to issue or update an accounting certificate 530. In this request, the amount of offer for service 510 that the user wants to use for a certain period is specified. Here, a pair of a public key 500A and a private key 500B for accounting is created. The public key 500A is sent to the certificate authority of accounting 300, included in the certificate request 530. The private key 500B is protected by, for example, a password 540 of the user.

The certificate authority of accounting 300 screens the certificate request by referring to an authentication policy 302 and past usage data 303 including balance accounts of a virtual organization to which the user 2 belongs. If the request is accepted, the certificate authority of accounting 300 sends back to the client system 20 of the user 2 an accounting certificate 500 including the public key 500A of the user 2 for accounting, the authorized amount (credit) 520 that the user 2 is allowed to spend for a certain period, and the authority's signature thereon made by using its private key 300B.

The user 2 verifies the contents of the accounting certificate 500 by using the public key 300A of the certificate authority of accounting 300 and stores the certificate 500 on the client system 20. The client system 20 stores the time to live and the authorized amount 520 that the user is allowed to spend until the expiry of the time period from the certificate 500 onto a storage medium 820 for remaining amount records. The client system 20 also stores the accounting certificate 500 received from the certificate authority of accounting 300 onto a storage medium 840 for certificates and related records.

As is shown in FIG. 2, the server 1 has a certificate 301 of the certificate authority for accounting including the public key 300A of the certificate authority of accounting 300. In synchronization with a certificate request to the certificate authority 3 (see FIG. 1), the server 1 sends the certificate authority of accounting 300 a request to issue or update an accounting certificate. In this request, a tariff (accounting policy) 410 that is valid for a certain period for computing resources or a service 9 that the server 1 manages is specified. Here, a pair of a public key 400A and a private key 400B for accounting is created. The public key 400A is sent to the certificate authority of accounting 300, included in the certificate request 430. The private key 400B is protected by root authority (system manager's authority) of the server 1.

The certificate authority of accounting 300 screens the certificate request, based on the authentication policy 302. If the request is accepted, the certificate authority of accounting 300 sends back to the server 1 a certificate (accounting certificate for server) 400 including the public key 400A of the server 1 for accounting, the tariff 410 that is valid for a certain period of usage of the server 1, and the authority's signature thereon made by using its private key 300B. The server 1 verifies the contents of the accounting certificate for server 400 by using its public key 300A and stores the certificate onto a storage medium 830 for certificates and related records.

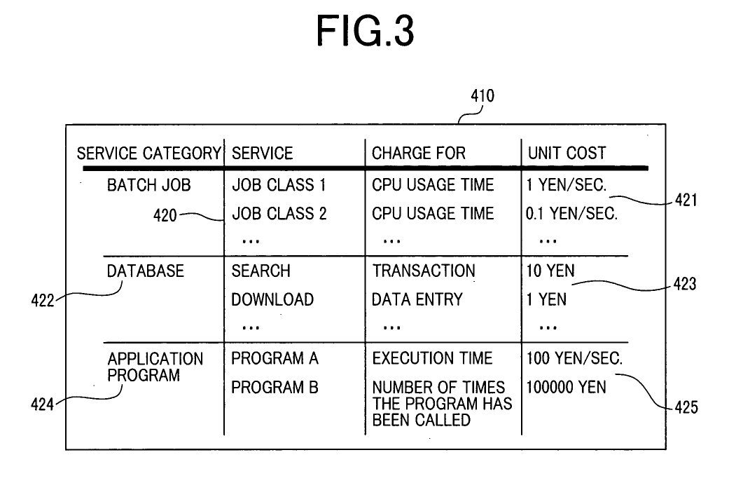

As is shown in FIG. 3, the tariff 410 comprises unit cost information 421 on a CPU usage time basis per job class 420 involving computing process queuing according to the process scale, unit cost information 423 for utilizing a search on a commercial database 421 or downloading data, and unit cost information 425 for utilizing a license key of a commercial application program 424.

If a request to update an accounting certificate is submitted to the certificate authority of accounting 300 concurrently whenever a request to update a certificate is submitted to the certificate authority 3, it may also be preferable to set the time to live shorter in the accounting certificate for server 400 and the accounting certificate for user 500 than the time to live in the certificates 4 and 5 for authentication and to submit a certificate update request 430 to the certificate authority of accounting 300 at shorter intervals.

The server 1 may register its tariff 410 for a service providing grid computing information so that the user 2 can find a server fit for his ability to pay by searching a list provided by the information providing service.

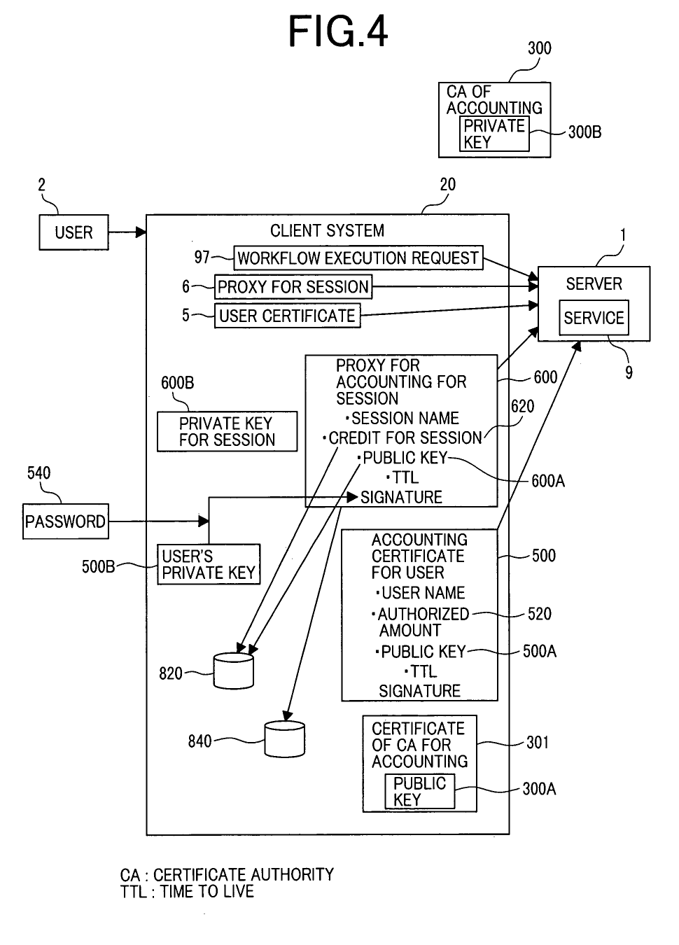

When initiating a session utilizing the grid computing, as shown in FIG. 1, the user 2 creates the pair of the public key 6A and the private key 6B for the session, which is used for authentication, and creates the proxy including the user's public key 6A and the user's signature thereon made by the private key 6B of the user 2. As is shown in FIG. 4, at this time, the user 2 also creates a pair of a public key 600A and a private key 600B for accounting of the session and a proxy for accounting (proxy for the session) 600. In this proxy, a credit 620 allocated for service usage in this session, a part of the authorized amount 520 that the user is allowed to spend during a certain period specified in the accounting certificate 500 authorized and signed by the certificate authority of accounting 300, is specified. The proxy also includes the user's signature thereon made by using the private key 500B of the user for accounting, retrieved by entering the password 540. The client system 20 of the user 2 passes the proxy 6 to the server 1 to which the request to execute the service process 9 is submitted.

At this time, the client system 20 stores the time at which the session begins, the credit 620 that the user is allowed to spend during the time to live of this session, the remaining amount less the above credit, the server name to which the request for the processing is submitted, and the organization name to which the user belongs onto the storage medium 820 for remaining amount records. The client system 20 also stores the issued proxy 600 onto the storage medium 840 for certificates and related records.

The proxy 600 is a credential based on public-key cryptography extended to enable inclusion of credit information 620, akin to the accounting certificate for user 500, and its time to live must be set rather short so that the period expires as soon as the requested service process 9 is completed.

The password 540, a workflow (a set of processes) 97 that the user wants to have executed in this session, and the credit 620 allocated to this session must be entered to the client system. Here, it is preferable to create an input form to enable the user to enter credit allocations 62, 621 to individual services 9, 91 constituting the workflow 97 so that the credit allocations to the individual services will be specified in the proxy 600. Also, the input form may be created to enable the user to assign a ratio of allocation for the individual services as well. The allocation details thus entered are specified in the proxy 600 for accounting which is passed to the server 1.

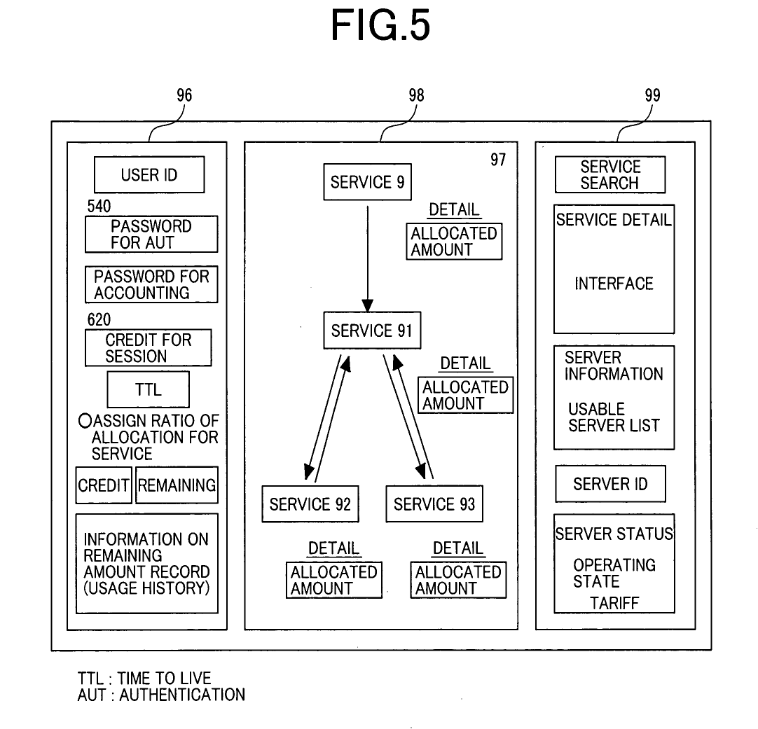

FIG. 5 shows an example of an input screen which the client system 20 presents when the user wants to initiate a session. The screen of FIG. 5 is made up of a window 96 comprising the entry boxes for passwords 540 and for the credit for the session 620 and the display box of remaining amount information stored on the storage medium 82, a window 98 where workflow process 97 components must be assigned, and a window 99 where information about the services constituting the workflow process 97 is displayed, such as a tariff, after being retrieved by an information providing service of the grid computing. Services 92 and 93 shown are the services for which the server 11 requested another server to execute them.

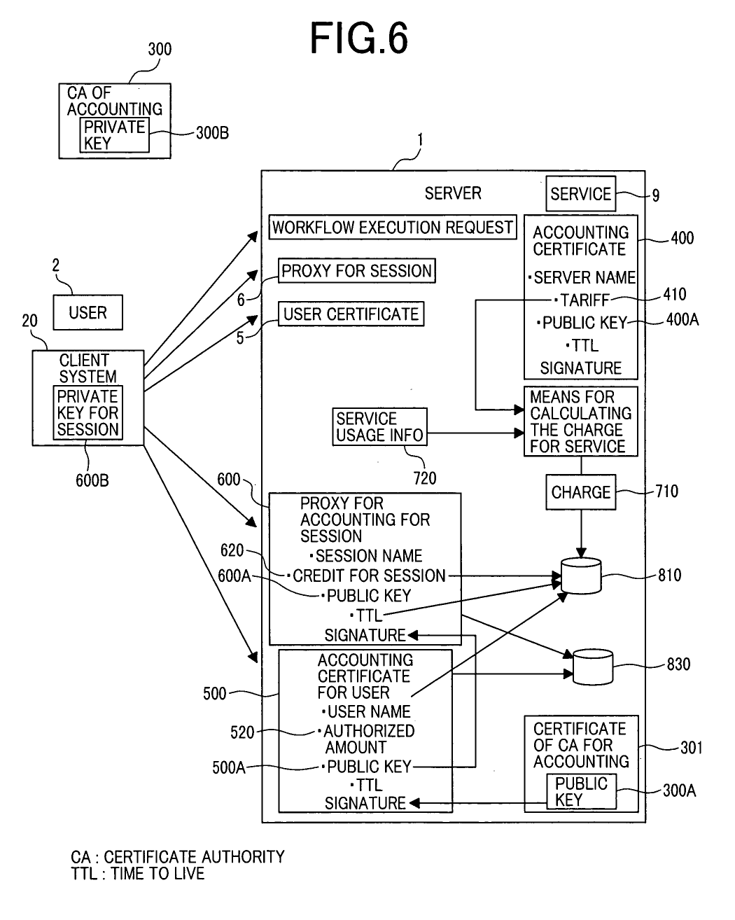

When the server 1 receives the request to execute the workflow 97 processing, the user certificate 5 for authentication, and the proxy 6 for the session from the user 2, the server 1 executes the service 9 processing by using the right of the user 2. As is shown in FIG. 6, at this time, the server 1 verifies the accounting certificate for user 500 and the proxy 600 for the session including the credit information, received simultaneously with the above certificate 5 and proxy 6, and stores these accounting certificate 500 and proxy 600 onto the storage medium 830 for certificates and related records. Also, the server 1 stores the time at which it received the request for the processing, the user name who issued the request for the processing, the organization name to which the user belongs, and the credit 620 that the user is allowed to spend for service usage in this session onto a storage medium 810 for cash flow records.

Verifying the received accounting certificate for user 500 and proxy 600 for the session is completed by making sure that the time to live does not expire, authenticating the signature on the accounting certificate for user 500 by using the public key 300A of the certificate authority of accounting retained on the server 1, and authenticating the signature on the proxy 600 for the session by using the user's public key 500A stated in the verified accounting certificate for user 500. In some implementation, a hierarchy of multiple certificate authorities of accounting may be set up. In this case, by tracing the signatories of the certificates of the multiple certificate authorities of accounting in a chain, the principal certificate authority of accounting that both the server 1 and the user 2 trust must be identified and its signature has to be authenticated.

The server 1 that executed the service 9 calculates a charge 710 for the service 9 in accordance with service usage information 720, such as the job class of the service executed and CPU usage time, and the tariff 410 with the signature of the certificate authority of accounting 300, and stores the thus calculated charge together with the time at which the service processing terminated, the user name who issued the request for the processing, and the organization name to which the user belongs onto the storage medium 810.

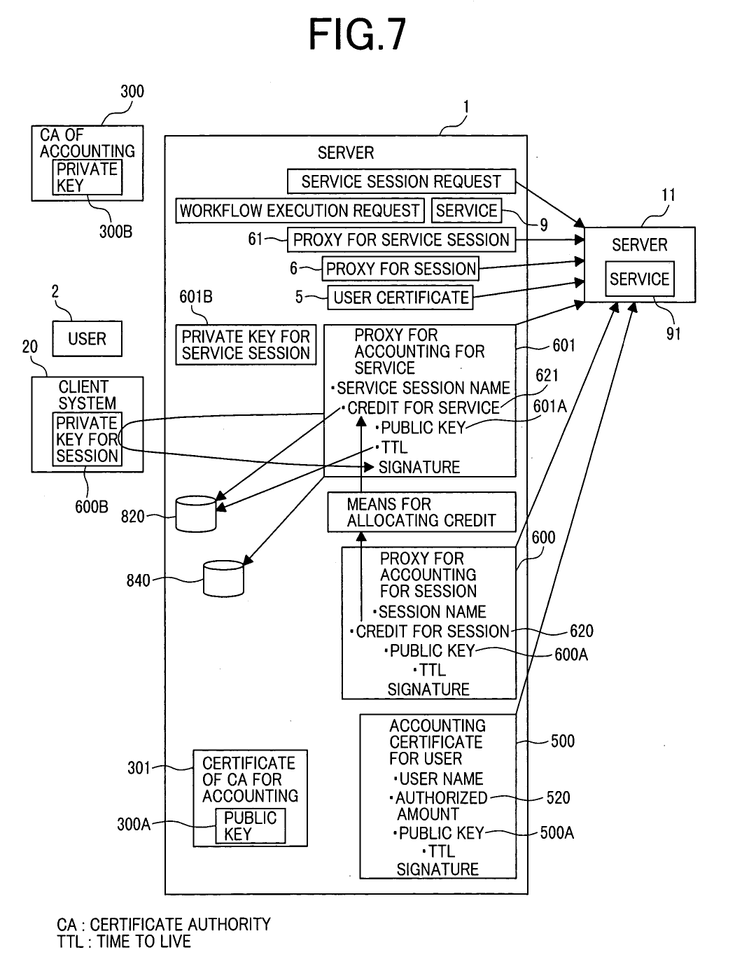

During or after the process execution of the service 9, if the server 1 calls on another server 11 to execute a service 91 processing, the server 1 creates a new pair of the public key 61A and the private key 61B for authentication, creates the proxy 61 including its pubic key 61A and the server's signature made thereon by using its private key 61B for the proxy 6, and passes the proxy to the server 11, thereby delegating the right of the user 2 to the server 11. As is shown in FIG. 7, at this time, the server 1 also creates a pair of a public key 601A and a private key 601B for accounting for the service and a proxy for accounting (second proxy) 601. In this proxy, a credit 621 allocated for the service 91 processing, a part of the credit 620 that the user is allowed to spend in this session, stated in the proxy 600 for accounting for the session with the signature of the user 2, is specified. The proxy is signed by using the private key 600B created at the time of initiating the session and passed to the server 11 to which the request for the service 91 processing is submitted. Here., because the private key 600B exists on the client system, in order to create the proxy 601, the following procedure is performed: the server 1 sends the client system 20 a proxy creation request including the public key 601A and the credit 621 and the client system 20 signs the proxy and sends back the proxy to the server 1.

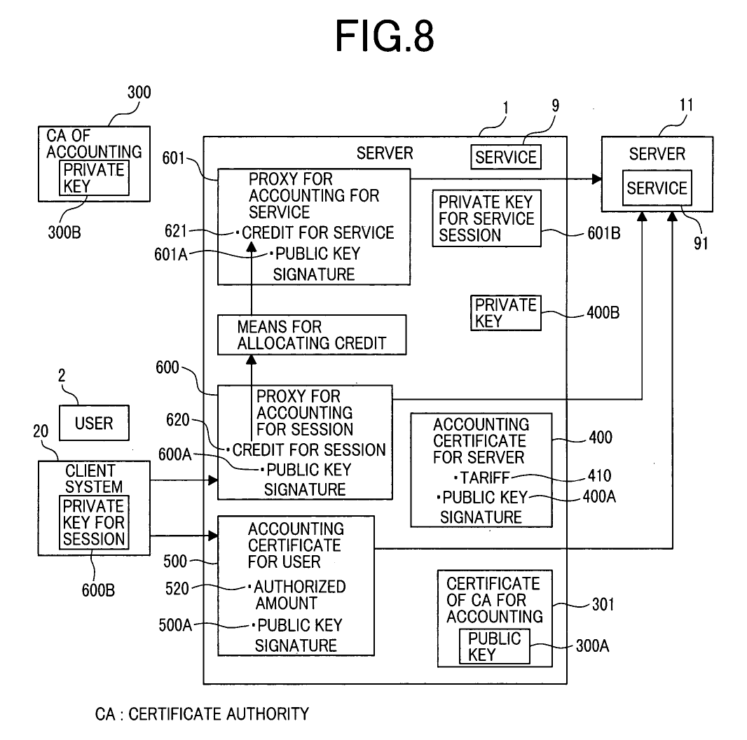

FIG. 8 illustrates a step in which the credit 621 is allocated for the service 91 and stated in the proxy 601 for accounting.

At this time, the server 1 stores the time at which it issued the request for the service 91 processing, the credit 621 that the user is allowed to spend for the service 91 processing, the server name to which the request for the processing is submitted, and the organization name to which the server belongs onto the storage medium 810. Also, the server 1 stores the proxy 601 onto the storage medium 830.

Here, the service 91 may be a workflow process consisting of a plurality of services.

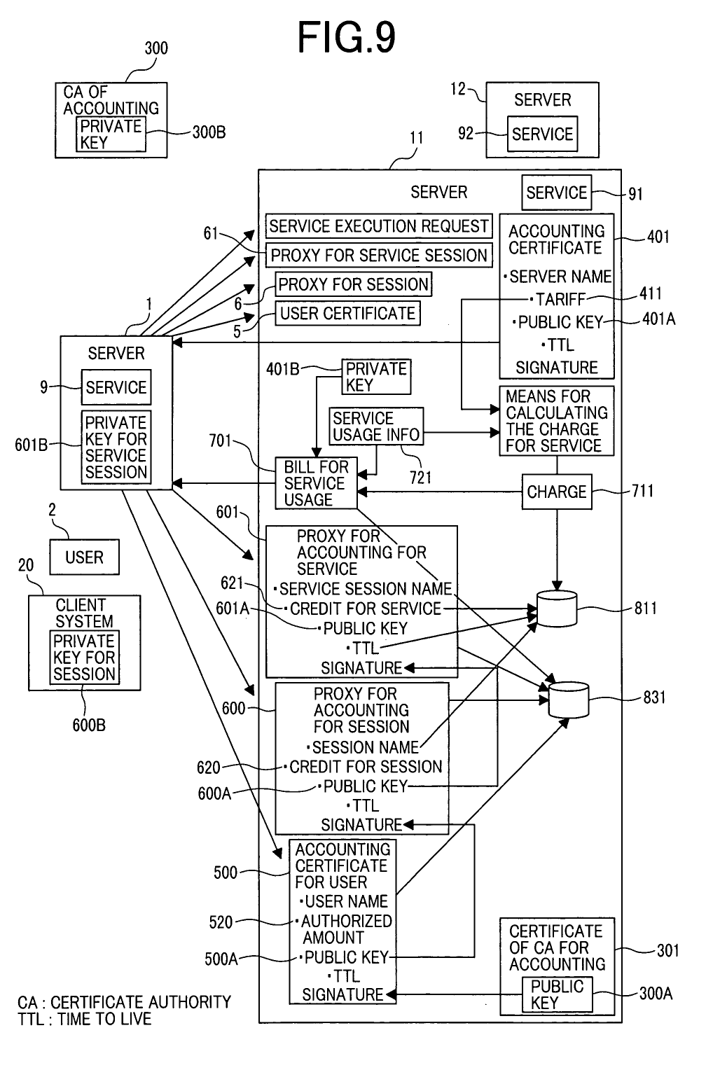

In FIG. 7, when the server 11 receives the request for the service 91 processing, the user certificate 5 for authentication, and the proxies 6 and 61 from the server 1, the server 11 executes the service 91 processing by using the right of the user 2. As is shown in FIG. 9, at this time, the server 11 verifies the accounting certificate for user 500 and the proxies 600 and 601, in which the credit information is stated, received simultaneously with the certificate 5 and the proxies 6 and 61, and stores these certificate 500 and proxies 600 and 601 onto a storage medium 831 for certificates and related records. Also, the server 11 stores the time at which it received the request for the processing, the server name that issued the request for the processing, the organization name to which the server belongs, and the credit 621 that the user is allowed to spend for the service 91 processing onto a storage medium 811 for cash flow records.

Verifying the received accounting certificate for user 500 and proxies 600 and 601 is completed by making sure that the time to live does not expire, authenticating the signature on the accounting certificate for user 500 by using the public key 300A of the certificate authority of accounting 300 retained on the server 11, authenticating the signature on the proxy 600 for the session by using the user's public key 500A stated in the verified accounting certificate for user 500, and authenticating the signature on the proxy 601 for the service by using the public key 600A stated in the verified proxy 600 for the session.

As is shown in FIG. 9, the server 11 that executed the service 91 calculates a charge 711 for the service 91 in accordance with service usage information 721, such as the job class of the service executed and CPU usage time, and the tariff 411 with the signature of the certificate authority of accounting 300, and stores the thus calculated charge together with the time at which the service processing terminated, the server name who issued the request for the processing, and the organization name to which the server belongs onto the storage medium 811.

In an instance where the service 91 is a workflow process consisting of a plurality of services, a request for service processing is submitted from the server 11 to some other server in the same procedure as described above. The server 11 creates a proxy 602 for accounting in which a credit 622 allocated for the service processing to be executed by the some other server, a part of the credit 621 stated in the proxy 601, is specified, and the request is completed through the procedure in which a chain of proxies are passed to the some other server.

In an instance where delegation of the user's right from the server 11 to some other server is no longer needed, the server 11 creates a bill for service usage 701 in which the charge 711 for the service 91 and the service usage information 721 such as the job class and CPU usage time are stated and signs the bill by using the private key 401B of the server 11 for accounting. The server 11 sends back this bill together with the accounting certificate for server 401 in which the pubic key 401A and the tariff 411 are stated to the server 1 that issued the request for the service 91 processing. Moreover, the server 11 stores the bill for service usage 701 onto the storage medium 831.

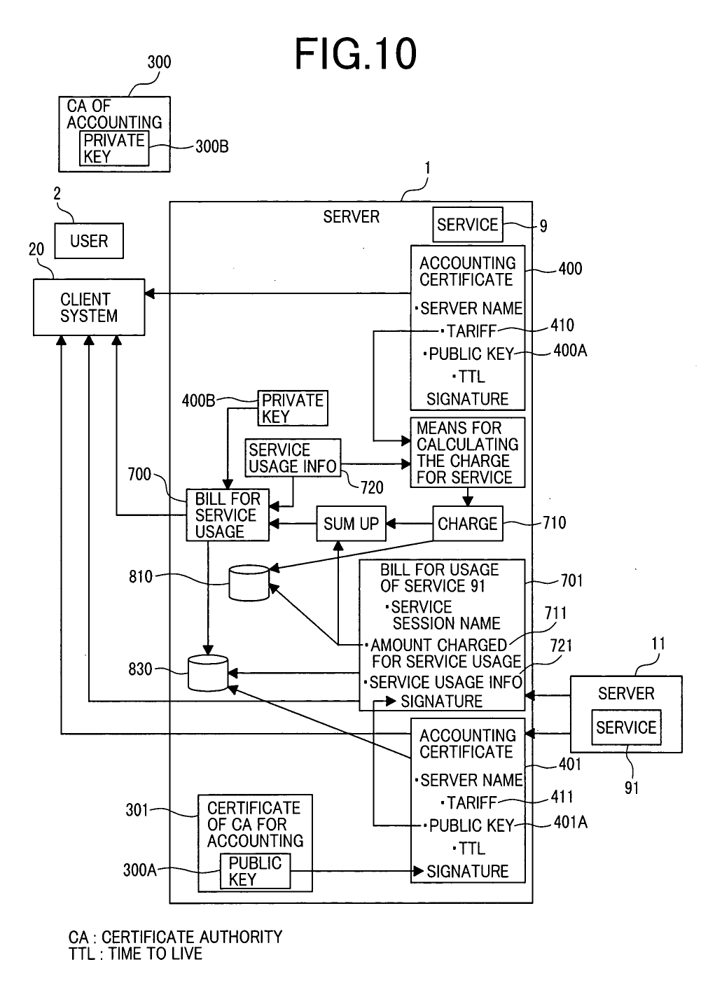

As is shown in FIG. 10, when the server 1 receives the bill for service usage 701, the server 1 authenticates the signature on the bill by using the public keys 300A and 401A and stores the bill onto the storage medium 830. Also, the server 1 stores the charge 711 for the service processing 91 together with the time at which it received the bill, the server name to which the request for the processing was submitted, the organization name to which the server belongs, the user name who issued the request for the processing, and the organization name to which the user belongs onto the storage medium 810.

After verifying that the workflow 97 processing requested from the user 2 terminates, the server 1 sums up the charge 710 for the service 9 it provided and the charge 711 stated in the bill for service usage 701 it received, creates a bill for service usage 700 service usage in which service usage information 720 is stated, wherein the service usage information 720 comprises information such as the job class and CPU usage time, which was used in calculating the charge 710, and a pointer to the bill for service usage 701 it received, and signs the bill by using the private key 400B of the server 1 for accounting. The server 1 sends back to the client system 20 that issued the request to execute the workflow 97 the bill for service usage 700 and the accounting certificate for server 400 including the public key 400A and the tariff 410, together with the bills for service usage for the services constituting the workflow 97 and the certificates of the servers that executed the services processing; namely, in the present example of embodiment, the bill for service usage 701 for the service 91 requested to the server 11 and the certificate 401 for the server 11.

Here, the accounting certificates 400 and 401 for the servers that executed the services processing must be sent to the client once within the time to live, but need not be sent at every session. In some implementation, it may also be preferable that the server 1 creates a bill for service usage 700 in which the bill for service usage 701 for the service 91 is integrated after its signature is authenticated, signs the bill by using its private key 400B, and sends back it to the client.

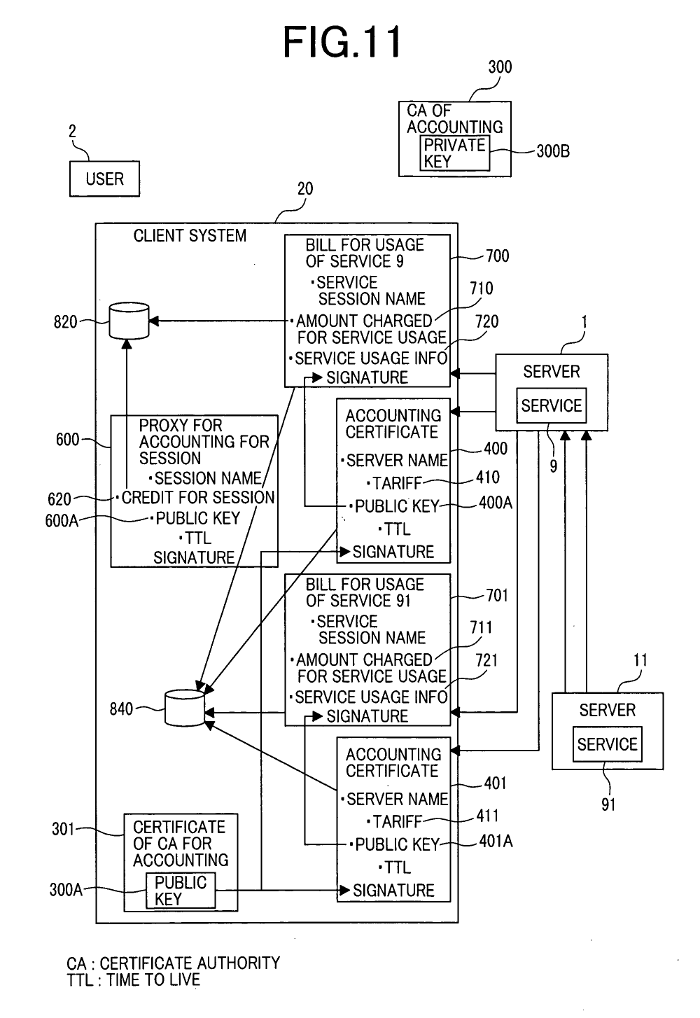

As is shown in FIG. 11, when the client system 20 receives the bills for service usage 700 and 701 and the accounting certificates 400 and 401 for the servers, authenticates the signatures on the above bills and certificates by using the public keys 300A, 400A, and 401A and stores the bills and certificates onto the storage medium 840. Also, the client system 20 stores the charge 710 total for the services 9 and 91 together with the time at which it received the bills for service usage, the server name to which the request for the processing was submitted, and the organization name to which the server belongs onto the storage medium 820. Moreover, the client adds the credit 620 that the user is allowed to spend within the time to live of the session to the remaining amount and stores the remaining amount onto the storage medium 820.

Alternatively, it may also be preferable that: the server 11 stores the charge 711 for the service 91 together with the user name that issued the request to execute the workflow 97 and the organization name to which the user belongs onto the storage medium 811, the server 1 creates a bill for service usage 700 without summing up the charge 710 and 711, and the client system 20 stores the charges 710 and 711 for the services 9 and 91 executed by the servers 1 and 11, which constitute the workflow 97, respectively, onto the storage medium 820. In this case, the bill for service usage 701 created on the server 11 should separately be sent back directly to the client system 20 without being routed via the server 1 and the bills for other service components of the workflow, if exist, should be done so from the servers that executed the services.

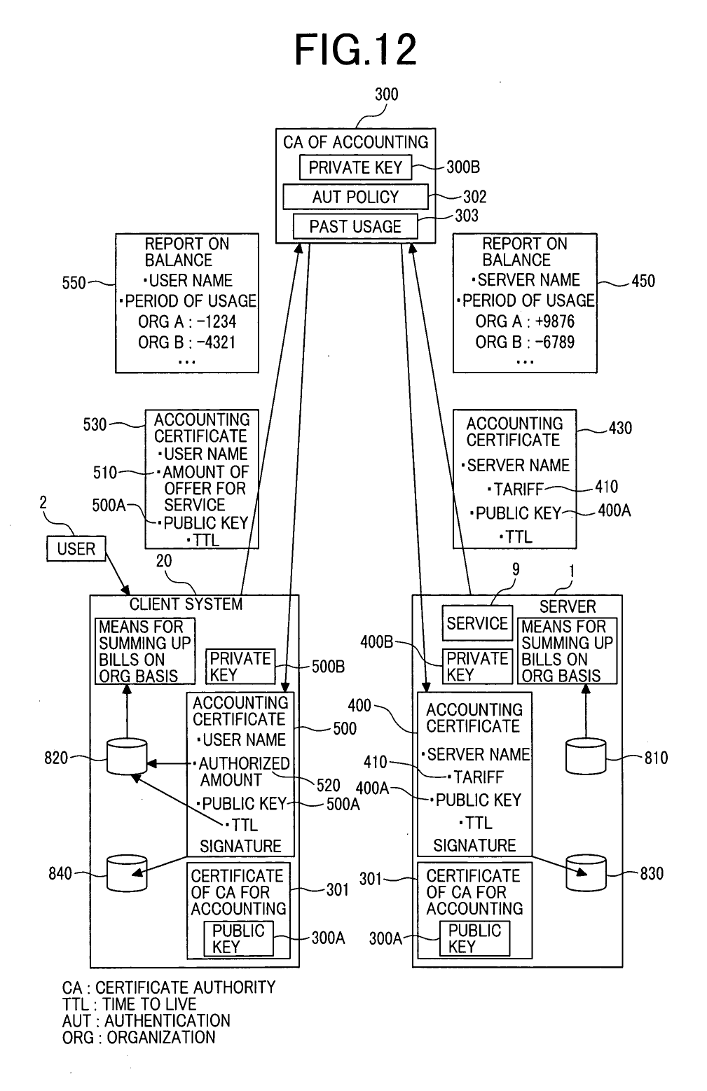

As is shown in FIG. 12, the client system 20 periodically creates a report on balance 550 in which service charges charged to the user 2 stored on the storage medium 820 for remaining amount records on the client system 20 are summed up per organization that provided a specific service and sends this report together with a request 530 to update the accounting certificate to the certificate authority of accounting 300. The server 1 creates a report on balance in which charges for the services it provided to the user or some other server and charges for the services provided by some other server, stored on the storage medium 810 for cash flow records on the server 1, are summed up per organization, and sends this report together with a request 430 to update the certificate to the certificate authority of accounting 300. This eliminates the need for exchanging accounting information directly between the service requester client or service execution server and a server that is responsible for centralized management of users or accounting information each time the workflow comes upon a charged service, and the burdens on the accounting management can be reduced.

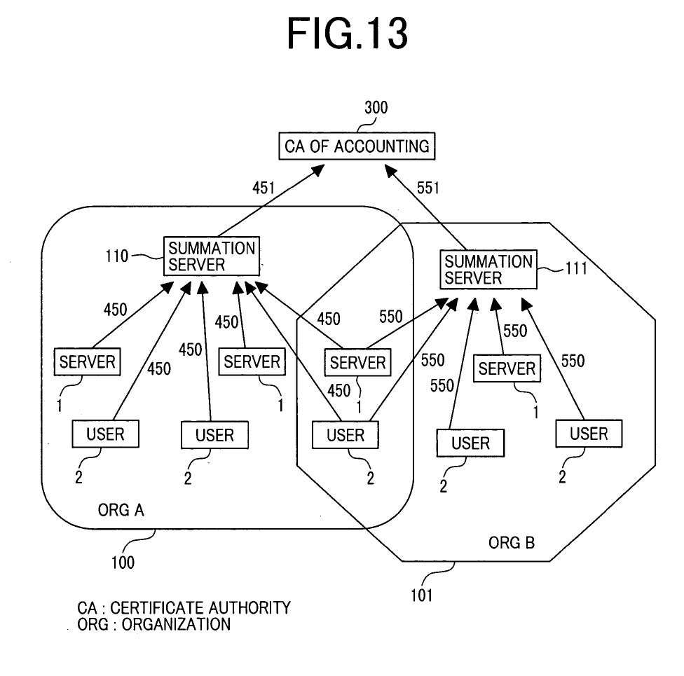

Moreover, as is shown in FIG. 13, organizations 100 and 101 respectively set up summation servers 110 and 111 for summing up balance information on an organizational basis from servers 1 and users 2 belonging to each organization. The reports on balance 450 and 550 from the client systems 20 and servers 1 are once received by the summation servers 110 and 111 from which reports on balance 451 and 551 as aggregation of balance on an organization basis are sent to the certificate authority of accounting 300.

This eliminates the need for the servers 1 to send the report on balance directly to the certificate authority of accounting 300 and can prevent the burdens on the certificate authority of accounting 300 from multiplying. In this manner, for a user belonging to a plurality of organizations, reports on balance are created by balance summation on an organizational basis, based on the organization name involved in a proxy created at the start of a session. If multiple services that different organizations provide respectively coexist to run on a same server, the summation servers 110 and 111 create balance reports for each organization that provides a specific service and then send the reports to the certificate authority of accounting 300.

Then, the certificate authority of accounting 300 creates a payment request or makes credit adjustment, according to past usage data 303 obtained from cumulative reports on balance. If necessary, an accounting audit can be performed, based on the certificates and proxies stored on the storage media 830, 831, and 840 for certificates and related records.

The present invention set forth hereinbefore makes it possible to provide charged services in safety in the grid computing environment, prevents tampering with identify and accounting information so it can ensure security and validity, and greatly reduces burdens imposed on accounting management. Even in circumstances where virtual organizations 100 and 101 make computing resources fluid, in other words, the computing resources are subject to change, accounting information can be managed through a chain of proxy transfers and, consequently, reliable accounting can be implemented.

The accounting management method of the present invention is characterized in that the certificate of a server includes a tariff (accounting policy) for resources under the management of the server and that a server comprises means for calculating a charge for service processing it executed, based on the tariff, creating a bill of the charge attached with the server's signature, and sending back the bill to the server or user that issued the request for the processing.

According to this method, service charges are calculated, based on the tariff authorized by the certificate authority of accounting, a third-party entity that both the user and the server trust and, therefore, the user can confirm the validity of the charging. Tempering with service charge information can be prevented, because service charge information is stated in certificates protected by public-key cryptography and signed by a chain of entities with the certificate authority of accounting, a third-party entity that both the user and the server trust, being on the top level.

The accounting management method of the present invention is characterized by including the storage media for storing the accounting certificates for user, accounting certificates for server, proxies including credit information, and bills for service usage, and means for periodically summing up the accounts of transactions between organizations to which each user and each server belong and reporting the aggregated accounts. By this method, debits and credits between virtual organizations are mutually balanced out periodically and, consequently, the burdens on a server manager can be reduced. Because accounting information from another party is stated in signed certificates, if a party has to undergo an accounting audit, the party can submit data as the basis for charging calculation and undergo the audit.

The accounting management method for use in grid computing in accordance with the present invention is characterized in that a client system of the user who takes advantage of sharing the computing resources comprises means for submitting a request to issue credit (authorized amount 520) that can be spent to use shared resources of grid computing to the certificate authority of accounting when submitting a request to newly issue or periodically update the user's certificate for authentication of the user and means for, when initiating a session, creating a proxy including a statement of a credit allocated for service usage in the session as a part of the credit stated in the accounting certificate for user authorized and signed by the certificate authority of accounting, signing the proxy, and passing the proxy to a server to which a request for service processing is submitted.

Through this method, by simply creating a proxy in which credit information is stated when initiating a session, according to a procedure similar to the single sign-on method, the user can utilize charged services. Tempering with credit information can be prevented, because credit information for using charged services is stated in certificates protected by public-key cryptography and signed by a chain of entities with the certificate authority of accounting, a third-party entity that both the user and the server trust, being on the top level.

The accounting management method of the present invention is characterized in that the client system further comprises means for assigning credit allocations to individual services constituting a workflow and means for creating a proxy for the session including information on the credit allocations to the individual services, signing the proxy, and passing the proxy to a server to which a request for service processing is submitted.

By this method, when the server to which the user submits a request for service processing calls on another server to execute a part of the processing in a concatenate way, the user can specify a credit allocated for sub-processing as a part of the credit stated in the proxy for the session.

The accounting management method of the present invention is characterized in that the client system comprises a step of, upon termination of a series of services processing, receiving bills for service usage signed by the servers that executed the services processing and the certificates of the servers in which the server's public key and the tariff information are stated from the server to which the request for processing was submitted, storage media for storing the proxies including credit information, the bills for service usage, and the certificates of the servers, and means for periodically summing up the accounts of transactions between organizations to which each user and each server belong and reporting the aggregated accounts.

By this method, debits and credits between virtual organizations are mutually balanced out periodically and, consequently, the burdens on a server manager can be reduced. Because accounting information from another party is stated in signed certificates, if a party has to undergo an accounting audit, the party can submit data as the basis for charging calculation and undergo the audit.

The accounting management method of the present invention is characterized by including a summation server which sums up the periodically reported accounts of transactions between organizations to which each user and each server belong per virtual organization and reports the aggregated accounts to the certificate authority of accounting.

By this method, the accounting information is reduced to aggregated accounts of debits and credits between virtual organizations which are mutually balanced out periodically and, consequently, the burdens on a server manager involved in accounting management and the burdens on the certificate authority of accounting can be reduced.

The accounting management method of the present invention is characterized by including the certificate authority of accounting which delegates the user right through a chain of user certificate and proxy transfers on the basis of public-key cryptography, in conjunction with or in parallel with the mechanism enabling single sign-on, signs and issues a certificate including a credit amount that a user is allowed to spend to utilize grid computing resources shared across users in accordance with the user's entitlement, signs and issues a certificate including a tariff for resources under the management of a server, receives periodical reports on the accounts of debits and credits balanced out mutually between virtual organizations, aggregated per virtual organization, issues a payment request, performs an accounting audit, and revises the credit.

As a whole, the accounting management method for use in grid computing in accordance with the present invention is characterized by comprising: the certificate authority of accounting which delegates the user right through a chain of user certificate and proxy transfers on the basis of public-key cryptography and manages accounting based on public-key cryptography in conjunction with or in parallel with the mechanism enabling single sign-on; means in which a user submits a request to issue credit that can be spent to use shared resources of grid computing to the certificate authority of accounting when submitting a request to newly issue or periodically update the user's certificate for authentication of the user; means in which the certificate authority of accounting signs and issues an accounting certificate for user in which a credit amount set in accordance with the user's entitlement is stated; means in which a server applies for authorization of a tariff (accounting policy) for resources under its management to the certificate authority of accounting when submitting a request to newly issue or periodically update the server's certificate for authentication of the server; means in which the certificate authority of accounting signs and issues a certificate including the tariff; means in which, when initiating a session, the user creates a proxy including a statement of a credit allocated for service usage in the session as a part of the credit authorized by the certificate authority of accounting, signs the proxy, and passes the proxy to a server to which a request for service processing is submitted; means in which, if the server calls on some other server to execute a part of the processing in a concatenate way, the server creates another proxy including a statement of a credit allocated for sub-processing as a part of the credit stated in the proxy, signs the proxy, and passes the proxy to the some other server to which a request for processing is submitted; means in which a server calculates a charge for service processing it executed, based on the tariff authorized by the certificate authority of accounting, creates a bill of the charge attached with the server's signature, and sends back the bill to the server or user that issued the request for the processing; storage media on which the user and the server store the accounting certificate for user or the accounting certificate for server, proxies including credit information, and bills for service usage which are exchanged during the foregoing procedure for utilizing grid computing resources; a storage medium on which the user stores information about the remaining amount of credit; a storage medium on which the server stores statistical information about resources usage; means for periodically summing up the accounts of transactions between organizations to which each user and each server belong and reporting the aggregated accounts to the certificate authority of accounting; and means in which the certificate authority of accounting issues a payment request and performs an accounting audit when inconsistency is detected.

Alternatively, the present invention may be embodied as an accounting management method for use in grid computing characterized in that the client system comprises a step of, upon termination of a series of services processing, receiving bills for service usage signed by the servers that executed the services processing and the certificates of the servers in which the server's public key and the tariff information are stated from the server to which the request for processing was submitted, a step of storing the proxies including credit information, bills for service usage, and the certificates of the servers, and a step of periodically summing up the accounts of transactions between organizations to which each user and each server belong and reporting the aggregated accounts.

Alternatively, the present invention may be embodied as an accounting management method for use in grid computing characterized by comprising: the certificate authority of accounting which delegates the user right through a chain of user certificate and proxy transfers on the basis of public-key cryptography and manages accounting based on public-key cryptography in conjunction with or in parallel with a single sign-on authentication procedure; a step in which a client submits a request to issue credit that can be spent to use grid computing resources shared across a plurality of users to the certificate authority of accounting when submitting a request to newly issue or periodically update the client's certificate for authentication of the client; a step in which the certificate authority of accounting signs and issues an accounting certificate for user in which a credit amount set in accordance with the client's entitlement is stated; a step in which a server applies for authorization of a tariff for resources under its management to the certificate authority of accounting when submitting a request to newly issue or periodically update the server's certificate for authentication of the server; means in which the certificate authority of accounting signs and issues an accounting certificate for server including the tariff; a step in which, when initiating a session, the client creates a proxy including a statement of a credit allocated for service usage in the session as a part of the credit authorized by the certificate authority of accounting, signs the proxy, and passes the proxy to a server to which a request for service processing is submitted; a step in which, if the server calls on a subordinate server to execute a part of the processing in a concatenate way, the server creates another proxy including a statement of a credit allocated for sub-processing as a part of the credit stated in the proxy, signs the proxy, and passes the proxy to the subordinate server to which a request for processing is submitted; a step in which a server calculates a charge for service processing it executed, based on the tariff authorized by the certificate authority of accounting, creates a bill of the charge attached with the server's signature, and sends back the bill to the server or user that issued the request for the processing; a step in which the client and the server store the accounting certificate for user or the accounting certificate for server, proxies including credit information, and bills for service usage which are exchanged; a step in which the client stores information about the remaining amount of credit; a step in which the server stores statistical information about resources usage; a step of periodically summing up the accounts of transactions between organizations to which each user and each server belong and reporting the aggregated accounts to the certificate authority of accounting; and a step in which the certificate authority of accounting issues a payment request and performs an accounting audit when inconsistency is detected.

What is claimed is:

1. An accounting management method for use in a grid computing system comprising a plurality of servers, each having computing resources which are shared across a plurality of clients, said accounting management method for use in grid computing comprising:
a step in which a certificate authority of accounting puts its digital signature on a tariff for computing resources, set by each of said plurality of servers, and issues an accounting certificate for server including said tariff to each server;
a step in which, in response to a request to issue an accounting certificate from a client, said certificate authority of accounting issues the accounting certificate for resources user including a statement of a credit authorized for the client user, attached with said certificate authority's digital signature thereon, to the client;
a step in which, when initiating a session in which the said client submits a request for service processing to a first server and obtains a response, said client sends said accounting certificate for resources user and a first proxy in which a credit allocated for service usage in the session as a part of said credit is stated and with said client user's digital signature thereon to said first server; and
a step in which said first server authenticates the digital signature attached to said accounting certificate for resources user and the digital signature on said proxy in a concatenate way by using a public key of the certificate authority of accounting.

2. The accounting management method according to claim 2, wherein said accounting certificate for resources user includes a public key from a pair of the public key and a private key created by said user and digital signature is put on said first proxy by using the private key from said pair.

3. The accounting management method according to claim 2, wherein a process of said session includes a step in which a second server executes at least a part of the service processing requested from said client by request from said first server and, when said first server calls on said second server to execute at least the part of said service processing, said first server creates a second proxy in which a credit allocated for sub-processing to be executed by the second server as a part of said credit stated in the first proxy received from said client and sends the second proxy to the second server.

4. The accounting management method for use in grid computing according to claim 3, wherein the server that executed processing calculates a charge for the processing, based on the tariff attached with the digital signature of said certificate authority of accounting, creates a bill of the charge attached with the server's digital signature, and sends back the bill to the server or the client that issued the request for the processing.

5. The accounting management-method for use in grid computing according to claim 3, wherein said first server receives from said second server a first charge bill in which the charge for the processing requested to said second server is stated, creates a second charge bill in which the charge for the processing the first server executed is added to the charge stated in the first charge bill, puts the first server's digital signature on the second charge bill, and sends back the second charge bill to said client.

6. The accounting management method for use in grid computing according to claim 4, wherein said plurality of servers respectively belong to any of a plurality of organizations and at least one server belonging to an organization receives charge bills from other servers belonging to the organization, sums up charges within the organization, and periodically reports accounts of transactions with another organization to said certificate authority of accounting.

7. The accounting management method for use in grid computing according to claim 1, wherein said accounting certificate for resources user includes a statement of a credit that can be spent to utilize computing resources as the credit authorized for said user within a first time to live and said first proxy includes a statement of a credit that can be spent in said session within a second time to live that is specified shorter than said first time to live.

8. The accounting management method for use in grid computing according to claim 1, wherein the client assigns credit allocations to individual services constituting a workflow and said proxy including information on the credit allocations to the individual services is passed to a plurality of servers to which a request for processing is submitted.

9. In grid computing in which the user right of a client is delegated from one sever to another through a chain of transfers of an accounting certificate for resources user and proxies on the basis of public-key cryptography, an accounting management method for use in the grid computing comprising:
a step of signing and issuing a certificate including a statement of a credit amount that a client is allowed to spend to utilize grid computing resources shared across users in accordance with the client's entitlement to the client in conjunction with or in parallel with a single sign-on authentication procedure;
a step of signing and issuing a certificate including a tariff for resources under the management of a server to the server; and
a step of receiving periodical reports on accounts of charges summed up per organization for all organizations to which one or more servers belong, wherein the accounts of transactions between organizations are balanced out mutually whenever summed up, issuing a payment request, performing an accounting audit, and revising the credit.

10. An accounting management apparatus for use in grid computing comprising:
servers, each having computer resources which are shared across a plurality of clients or with other servers;
a first certificate authority which manages authentication of said clients and said servers with regard to access rights, based on public-key cryptography;
a second certificate authority which manages authentication of said clients and said servers with regard to accounting, based on public-key cryptography,
wherein said second certificate authority comprises:
means for issuing an account certificate for resources user including credit in response to a request from said clients;
means for issuing an account certificate for sever including a tariff for service processing in response to a request from said servers; and
means for receiving and summing up charges for executed service processing from said servers.

11. The accounting management apparatus for use in grid computing according to claim 10, wherein said summing-up means receives the charges from summation servers, each being deployed for each of a plurality of organizations, and sums up the accounts of transactions between organizations.
